(19) United States
(12) Patent Application Publication
(10) Pub. No.: US 2013/0201498 A1
(43) Pub. Date: Aug. 8, 2013

(54) Methods for Improving Color Differentiation by Dot Placement Manipulation and Color Hue Adjustment

(71) Applicant: Lexmark Intenational, Inc., Lexington, KY (US)

(72) Inventors: Aaron Jacob Boggs, Lexington, KY (US); Lane Thomas Butler, Lexington, KY (US); Scott Timothy Cramer, Lexington, KY (US); Matthew Ryan Keniston, Lexington, KY (US); Rodney Evan Sproul, Lexington, KY (US); Daniel Lee Thomas, Lexington, KY (US)

(73) Assignee: LEXMARK INTENATIONAL, INC., Lexington, KY (US)

(21) Appl. No.: 13/731,523

(22) Filed: Dec. 31, 2012

Related U.S. Application Data
(63) Continuation of application No. 13/368,548, filed on Feb. 8, 2012.

(51) Int. Cl. H04N 1/60

(52) U.S. Cl. CPC H04N 1/60
USPC 358/1.9

(57) ABSTRACT

A method of improving color differentiation includes receiving an original image containing color pels of a plurality of colors, detecting at least one region of interest in the original image, and modifying the an original image to improve a contrast between a color pel of a first color and a color pel of a second color. The contrast may be improved by removing and/or adding a color pel of a first color.

### CROSS REFERENCE TO RELATED APPLICATIONS

This application is a continuation application of application Ser. No. 13/368,548, filed Feb. 8, 2012, entitled “Methods for Improving Color Differentiation by Dot Placement Manipulation and Color Hue Adjustment,” the contents of which is hereby incorporated by reference herein in its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates to imaging science, and, more particularly, to improving color differentiation in images.

2. Description of the Related Art

Typical laser, inkjet and other types of imaging devices utilize a four-color system to produce a printed output. Yellow, cyan, magenta and black colored inks or toners are used to create a color gamut. In some systems, additional colors such as green, orange, purple and white, as well as various shades of red and blue are also used to improve the size and range of colors that the imaging device can produce. Typically, there is no physical mixing of the ink or toner prior to printing to form a color. When the imaging device is tasked to print an image with, for example, the color green, the green color may be printed by utilizing yellow and cyan pigmented and/or dye-based materials. A printed pel of yellow and a printed pel of cyan may be printed close to each other so that the over-all appearance of the light reflecting off the substrate back to a user would reflect both the yellow and cyan wavelength, thus resulting to an appearance of the green color.

Colors that users see on a printed substrate correspond to the amount of each wavelength of light that is reflected off the substrate in close proximity to each other. For someone who is color deficient, the complete or partial absence of one or more pigments in at least one of the eyes results in the person's difficulty or inability to differentiate between some colors in the visible color spectrum. People with color deficiency may also have difficulty reading or differentiating colors that are used in printed or displayed data, especially when the colors are used in small areas. However, it should be noted that people with color deficiency typically have a better sense of contrast compared to individuals with no color deficiencies.

Accordingly, there is a need for a method that improves color differentiation of a colored image, document and/or graphic that allows individuals with and without color deficiencies to see the desired content on a printed substrate or on a display as the author or creator intended. There is a need for a solution that allows individuals with color deficiencies to differentiate one color from another without dramatically changing the color hue of the content for individuals without color deficiencies.

### SUMMARY

Methods of improving color differentiation are disclosed therein. In one example embodiment, the method may include receiving an original image containing color pels of a plurality of colors, detecting at least one region of interest in the original image, and modifying the original image to improve a contrast between a first color and a second color of the plurality of colors.

In one aspect, the modifying may include removing a color pel having the first color from at least one region of interest. In another aspect, the modifying may include adding the color pel having the first color to the at least one region of interest.

In one aspect of an example embodiment, the method may further include creating an outline of the at least the region of interest adding at least one color pel around the color pels of the first color in the region of interest. In another aspect of an example embodiment, the method may further include creating an outline of the at least the region of interest by removing at least on color pel around the color pels of the first color from the at least one region of interest.

In some example aspects, the removing the color pel may be based on a formula. In other example aspects, the removing the color pel may be based upon a color table adjustment factor that shifts the plurality of colors of the color pels in the at least one region of interest.

In some example embodiments, the at least one region of interest is a potentially problematic region of a color spectrum for individuals with color deficiency.

In still other example embodiments, the method may include sending the modified image to an imaging device for printing.

Other embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is a block diagram of a document processing system.

FIG. 2 is a flowchart of one example method of improving color differentiation.

FIG. 3 is a flowchart of a second example method of improving color differentiation.

FIG. 4 is a flowchart of a third example method of improving color differentiation.

FIGS. 5, 6, 7, 8, 9 and 10 are example embodiments of improving color differentiation for use in conjunction with the method of FIG. 2.

FIGS. 11, 12 and 13 are example embodiments of improving color differentiation for use in conjunction with the example method of FIG. 3.

FIGS. 14, 15 and 16 are example embodiments of improving color differentiation for use in conjunction with the example method of FIG. 4.

### DETAILED DESCRIPTION OF THE DRAWINGS

The following description and drawings illustrate example embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the disclosure encompasses the appended claims and all available equivalents. The following description is, therefore, not to be taken in a limited sense, and the scope of the present disclosure is defined by the appended claims.

It is also to be understood that the phraseology and terminology used herein is for the purpose of description and should not be regarded as limiting. The use herein of “including,” “comprising,” or “having” and variations thereof is meant to encompass the items listed thereafter and equivalents thereof, as well as additional items. Unless limited otherwise, the terms “connected,” “coupled,” “mounted” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity, but rather denote the presence of at least one of the referenced item.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions, which execute on the computer or other programmable data processing apparatus, may create means for implementing the functionality of each block of the diagrams or combinations of blocks in the diagrams discussed in detail in the descriptions below.

These computer program instructions may also be stored in a non-transitory computer-readable medium that may direct a computer or other programmable data processing apparatus to function in a particular manner, such that the instructions stored in the computer-readable medium may produce an article of manufacture including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, may be implemented by special purpose hardware-based computer systems that perform the specified functions or steps or by combinations of special purpose hardware and computer instructions.

Disclosed are a system and methods of improving color differentiation by manipulating the dot placement and adjusting the color hue of an image. The methods of improving color differentiation may involve altering a colored image, document and/or graphic that allows individuals with and without color deficiency to see the content on a printed substrate or output device through color hue and contrast differences. The methods may include various means of altering the color dot placement and the hue of a colored image, document and/or graphic which may include application of patterns or execution of algorithms to move pels closer to and/or further from one another. Some methods to improve color differentiation may remove and/or add pels to some portions of the processed image, document and/or graphic. Some methods may keep the color hue the same in the original and processed image and only alter the contrast while other methods may alter both the contrast and color hue. The alteration of contrast may be achieved by organizing the proximity of like color pels on the micro scale to improve color and contrast differences in the content, thereby allowing individuals with and without color deficiency to see the desired content on a printed substrate or on a display.

For purposes of the present disclosure, it will be appreciated that the term image may refer to documents, photos or any other file that may be used to generate or produce a printed output on a media or a visual output on a display, such as, for example, a computer monitor that may be part of or associated with a client device. The process for printing the one or more images may require that the one or more of the images be processed and/or reassembled into a format that resembles that which is displayed on an interface when the one or more images are accessed. If the one or more images displayed on or retrieved by the imaging device are not in a format that the imaging device recognizes or is capable of printing, a transform or conversion process may be performed on the one or more images in order to convert the one or more images into a format recognizable by the imaging device, i.e., a printable format. Printable formats may include, but are not limited to, PCL, PostScript, JPEG and PDF formats.

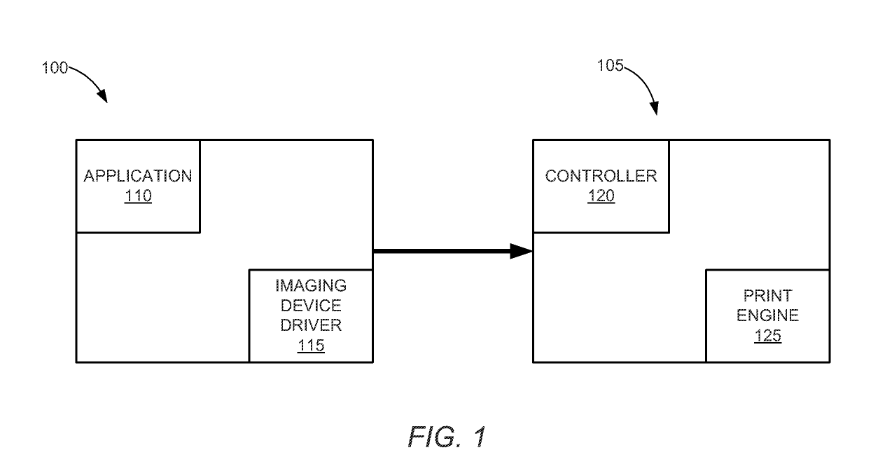

Referring to FIG. 1, there is shown a block diagram of a document processing system including a client device 100 that may be communicatively connected to an imaging device 105, according to one example embodiment. Client device 100 may include an application 110 that may produce a colored image to be printed on imaging device 105, an imaging device driver 115 and a display (not shown). Imaging device 105 may include a controller 120 and a print engine 125.

Client device 100 may be connected to imaging device 105 as shown in FIG. 1. Client device 100 may be connected to imaging device 105 via a communication link, which may be established by a wired or wireless connection such as, for example, an Ethernet connection. Client device 100 may be a computer or processor-based device capable of communicating with a communications network via a signal, such as a wireless frequency signal or a direct wired communication signal. A respective communication interface associated with client device 100 may facilitate communications between client device 100 and imaging device 105.

Client device 100 may be a computing device such as, for example, a personal computer, a mobile device, an image-capturing device, a tablet computer or any device that includes a processor (not shown) and a computer-readable medium (not shown), such as a random access memory (RAM), coupled to the processor. The processor may execute computer-executable program instructions stored in the memory. Computer executable program instructions stored in the memory may include an imaging device driver 115. Imaging device driver 115 may implement a set of instructions adapted to process an image to improve contrast difference between at least two colors in the image.

Application 110 may be executed in client device 100. Application 110 may produce an image or a document containing an image to be sent to imaging device driver 115 for printing or to the display for displaying to a user of client device 100. Application 110 may be a word processor capable of producing documents that may be printed. Application 110 may also be a web browser capable of producing a print job from web pages accessed by a user of client device 100. It will be understood by one of ordinary skill in the art that application 110 may perform other processes to produce the image given the benefit of this disclosure.

During operation, client device 100 may include in the memory a software program including program instructions that may function as imaging device driver 115 for imaging device 105. Imaging device driver 115 may communicate with an ASIC (not shown) of imaging device 105 via a communications link that connects client device 100 with imaging device 105. Imaging device driver 115 may facilitate communication between client device 100 and imaging device 105. In addition, imaging device driver 115 may provide formatted print data to imaging device 105, as will be known to one of ordinary skill in the art.

A user of client device 100 may utilize a user interface (UI) (not shown) of client device 100 to view the image. The UI may include the display which may be, for example, a computer monitor for viewing the image and an input device (not shown), such as a keyboard or a pointing device (e.g., a mouse, trackball, pen, touch pad, or other device), for interacting with imaging device driver 115 or application 110 running on client device 100. In some example embodiments, the UI may have an integrated display and input device, such as a touch screen display.

Client device 100 may include in its memory software or firmware including program instructions which when executed, may process an image to improve contrast difference and/or color differentiation. A method for processing the image, as will be discussed in greater detail herein, may be part of imaging device driver 115. In one alternative example embodiment, the method may be executed in a separate application that may function in conjunction with imaging device driver 115 when the image is sent to imaging device 105 for printing. In another alternative example embodiment, the method may be executed by another application that may process the image prior to sending the image to the display of client device 100.

In yet another alternative example embodiment, the method may be stored in controller 120 of imaging device 105 that receives the image from client device 100 or from an image-capturing device (not shown), that processes the image to improve contrast difference and color differentiation, as described in greater detail below, and that sends the processed image to print engine 125 for printing. In yet other alternative example embodiments, the method may be stored in a device external but communicatively coupled to client device 100 and/or imaging device 105.

Imaging device 105 may be any device capable of printing or producing a hard copy data file or document stored in electronic form, such as a laser, inkjet or dot matrix printer or multi-function printing device that has the capability of performing other functions, such a faxing, e-mailing, scanning and/or copying, in addition to printing.

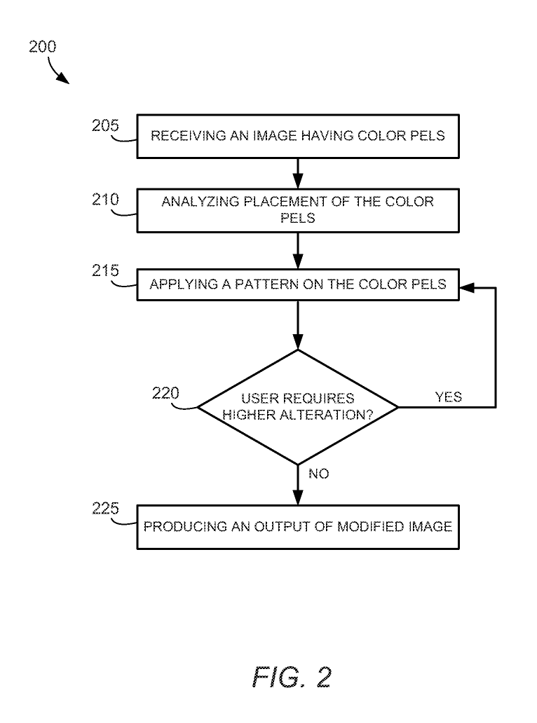

Referring to FIG. 2, there is shown one example flowchart of a method 200 of improving color differentiation. Method 200 may process an image prior to printing at imaging device 105 or prior to outputting the image in the display of client device 100 to improve color differentiation of the image. Method 200 may retain the number of pels and utilize the same amount of colors for the producing an output of the processed image as that of the original image so that individuals with no color deficiencies may not experience a loss in color. Method 200 may process the image to improve color differentiation by manipulating the dot placement to allow high and low concentration areas of specific colors so that individuals with difficulty discerning differences between some colors may distinguish contrast differences between the colors instead.

At block 205, imaging device driver 115 or controller 120 in imaging device 105 may receive an original image having color pels. The color pels may represent color hues in the original image. As set forth above, the original image may be received by imaging device driver 115 or controller 120 in imaging device 105 when the original image is to be formatted for printing by imaging device 105. In some alternative example embodiments, the original image may be received by another application running on client device 100 to process the original image for outputting in the display of client device 100.

At block 210, the color pels in the original image may be analyzed. The hue of the color pels in the original image may be determined in order to select a pattern to apply to the color pels for recreating the colors in the original image that may improve the contrast difference while retaining the color hues in the original image.

At block 215, a pattern may be applied to the color pels in the original image. The pattern applied may alter the contrast difference needed for color differentiation in the original image, thereby generating a modified image that may still maintain the hue of the original image. Applying the pattern recreates the colors in the original image by manipulating the placement of the color pels by moving them closer to or further from one another.

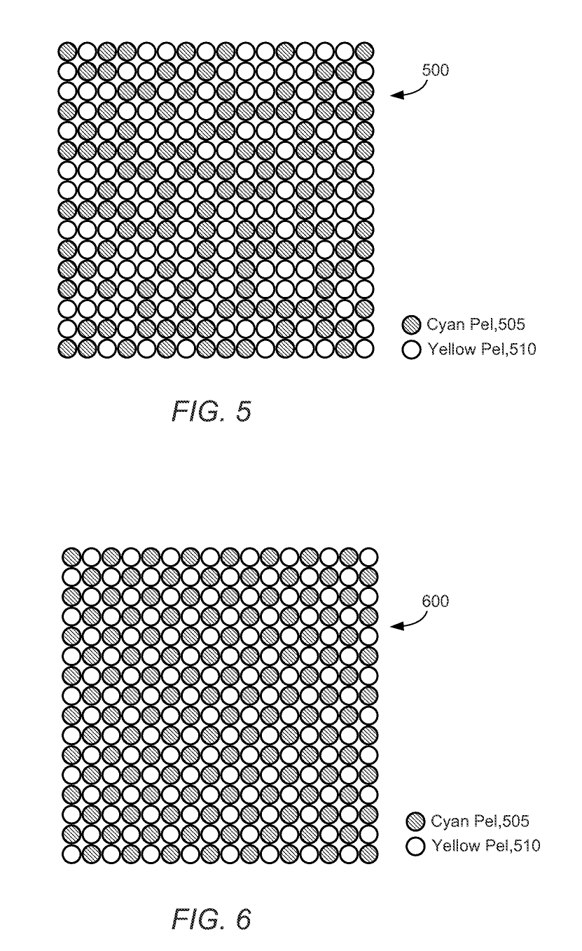

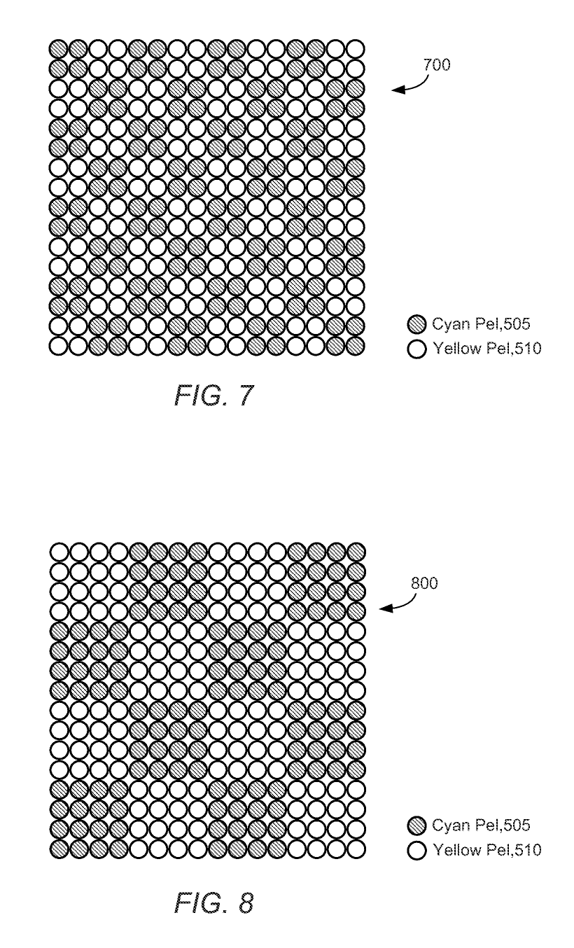

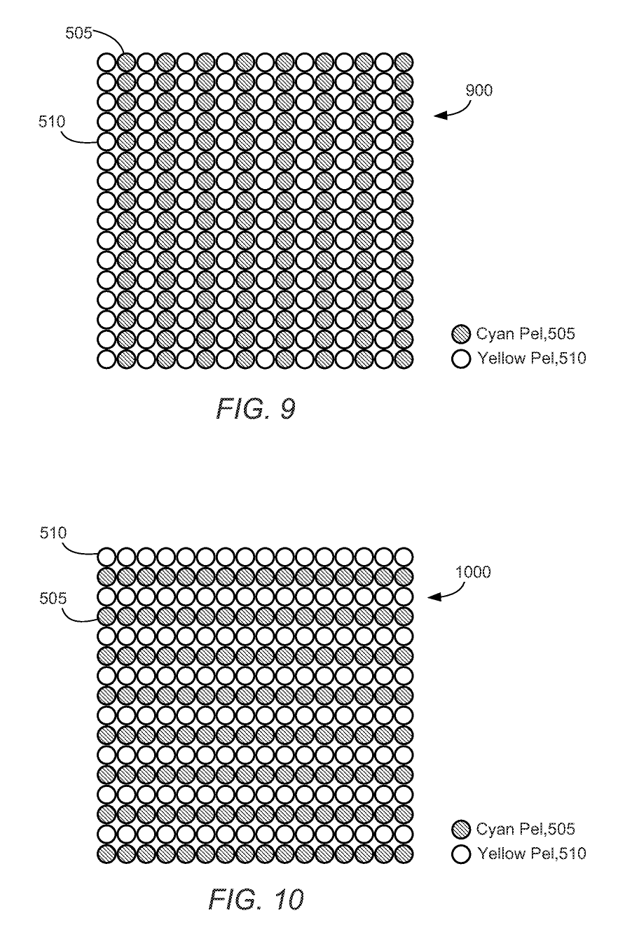

FIGS. 5, 6, 7, 8, 9 and 10 are example embodiments of improving color differentiation for use in conjunction with the method of FIG. 2. Original pattern 500, as shown in FIG. 5, is one example of producing a specific green hue by applying an original pattern containing cyan pels 505 and yellow pels 510.

FIGS. 6, 7, 8, 9 and 10 are modifications of the original pattern 500 and are example embodiments of improving color differentiation that apply patterns 600, 700, 800, 900 and 1000, respectively, on cyan pels 505 and yellow pels 510 in order to recreate the specific green hue in the original image. Like FIG. 5, FIGS. 6, 7, 8, 9 and 10 may also utilize the same number of cyan pels 505 and yellow pels 510.

In FIG. 6, the number of cyan pels 505 and yellow pels 510 in the original image and those used in pattern 600 to produce the green hue may be substantially equal. By utilizing the same amount of colors and the same number of color pels to reproduce a hue, individuals with no color deficiencies may not experience a loss in color while individuals with color deficiencies may differentiate one color from another using improved contrast differences between the colors. Manipulating the placement of the color pels by adding a pattern to reproduce a color in the original image may allow for high and low concentration areas of specific colors and may enable individuals that have difficulty discerning the differences between some colors to discern contrast differences.

The patterns utilized in FIGS. 6-10 may not be symmetrical in terms of geometric space, but the specific green hue that is recreated in the above-referenced illustrative embodiments have a unique and consistent pattern for all other similar green hues in the original pattern 500. For example, when pattern 600 shown in FIG. 6 is first used to recreate a specific green hue in the original image, pattern 600 may be the pattern applied to the original image to recreate all of the areas in the original image having the same, specific green hue.

It should be understood that the example embodiments shown in FIGS. 6, 7, 8, 9 and 10 are illustrative example embodiments and should not be considered the only possible color alterations, shapes, patterns or combinations of colors that may be utilized to produce a specific green hue. It will also be appreciated by one of ordinary skill in the art that aside from patterns, textures and/or layouts may also be used to recreate the colors of the original image. It will be understood that other color hues may also be recreated in other multi-color print systems apart from a cyan, magenta, yellow and black printing device.

The degree to which the original image may be altered may either be a configurable or a non-configurable setting for a user of client device 100 and/or imaging device 105. If the degree of alteration is configurable, at least one pattern may be applied repeatedly to the original image to produce various degrees of alteration. Referring back to FIG. 2, if the user requires a higher degree of alteration for the original image (block 220), the process returns to block 215 and reapplies the pattern to the original image. The reapplied pattern may be similar to the pattern first applied on the original image. In some example embodiments, the reapplied pattern may be a pattern different from the first applied pattern. The higher the degree of alteration the user requires for the original image, the more reapplications of the one or more patterns may be performed on the original image. In some alternative example embodiments, alternate patterns may be applied on the original image with each degree of alteration required by the user.

If another higher alteration is no longer required, an output of the modified image may be produced (at block 225). In one alternative example embodiment, the level of alteration of the original image may not be configurable or permitted. In such case, after applying a pattern on the color pels (block 215), an output of the modified image may be automatically generated (block 225).

The output may refer to print data corresponding to the modified image that is sent to print engine 125 of imaging device 105 or visual data that is presented on a display associated with client device 100 for viewing by the user of client device 100.

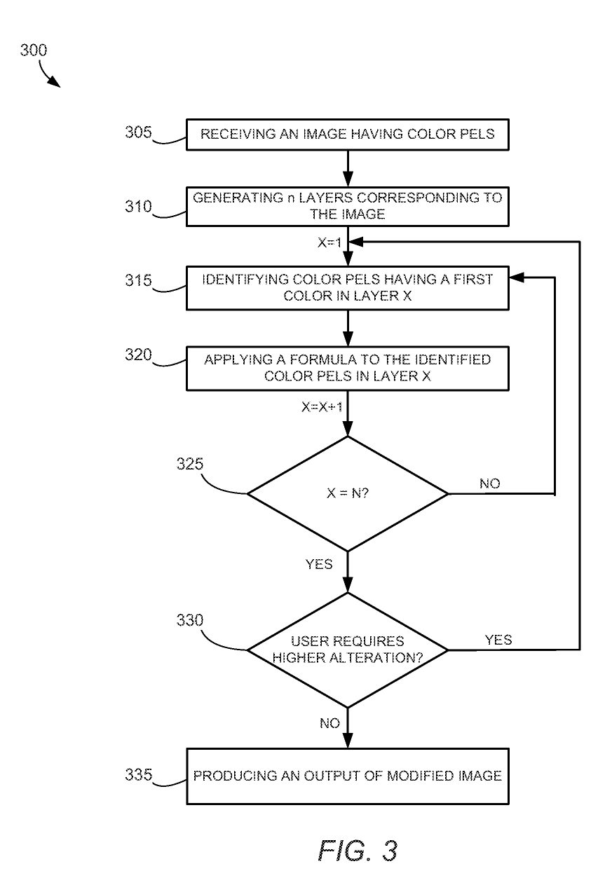

Referring to FIG. 3, there is shown a flowchart of a second example method 300 of improving color differentiation. Method 300 may process an image to improve color differentiation of the image prior to printing at imaging device 105 or prior to outputting the image in the display of client device 100. Method 300 may retain the same number of pels and utilize the same amount of colors in the processed image as those of the original image so that individuals with no color deficiencies may not experience a loss in color. Method 300 may improve contrast difference and/or color differentiation by manipulating the dot placement to allow high and low concentration areas of specific colors so that individuals with difficulty discerning differences between some colors may distinguish contrast differences between the colors instead.

At block 305, imaging device driver 115 or controller 120 in imaging device 105 may receive an original image having color pels. The color pels may represent color hues in the original image. As described above, the original image may be received by imaging device driver 115 or controller 120 in imaging device 105 when the original image is to be formatted for printing by imaging device 105. In some alternative example embodiments, the original image may be received by another application running on client device 100 to process the original image for outputting in the display of client device 100.

At block 310, a number N of layers corresponding to the original image may be generated. Each of the layers generated may be based on a level of hue or a specific color hue in the original image. In one example embodiment, a basic layering system may break the original image into four layers such as, for example, a cyan layer, a magenta layer, a yellow layer and a black layer. In another example embodiment, there may be more layers generated, with each layer corresponding to a particular level of hue in the original image such as, for example, a green, orange, purple, red, yellow, blue and black layer. It will be understood by one of ordinary skill in the art that other hues may be used to generate one or more layers corresponding to the image.

Generating more layers compared to the basic four-layer breakdown may further maintain the color distributions within the original image after the pels in each of the layers are processed, as will be discussed in greater detail below. Generating more layers that correspond to the original image may mitigate the degree of color mixing that may occur on the basic four-layer breakdown of the original image. While generating more layers may result in less of an ability to adjust the contrasts of the colors between layers, generating more than four layers may maintain a higher level of true color integrity.

At block 315, starting from a first layer, color pels in the layer having a first level of color hue corresponding to the original image may be identified. For example, if the basic four-layer breakdown of the original image is used, and there are four layers generated such as, for example, a cyan layer, a magenta layer, a yellow layer and a black layer, cyan pels in the cyan layer may be identified.

At block 320, a formula may be applied to the identified color pels in the first layer to adjust each layer and improve color differentiation in the original image starting from the first layer, thereby generating a modified image. The formula may manipulate the placement of the different color pels in the layer and allow for localized areas of a specific color, particularly the color of the layer being processed. For example, if the layer being processed is the cyan layer, the formula may be applied to the cyan pels to move the positions of the cyan pels in the layer, thereby concentrating the cyan pels and improving the contrast difference between cyan pels and other color pels in the modified image.

In one alternative example embodiment, the formula may cluster the identified color pels in the layer, thereby pulling the identified color pels closer together and creating more concentrated areas of color in the first layer. For example, if the layer being processed is the cyan layer, the formula may be applied to cluster cyan pels in the cyan layer and may gather the cyan pels closer to each other, thereby grouping them and creating more concentrated cyan-colored areas in the modified image.

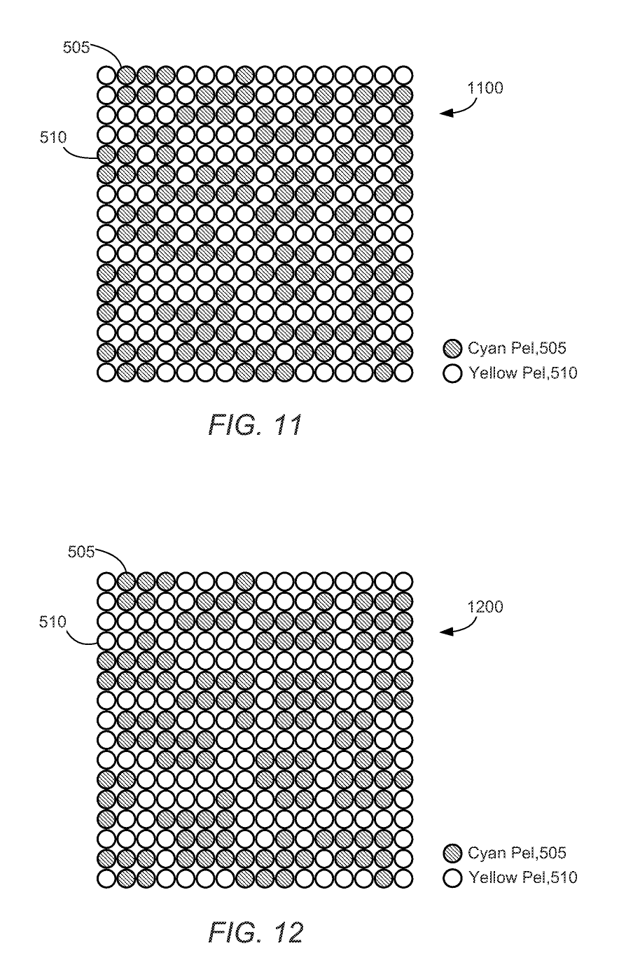

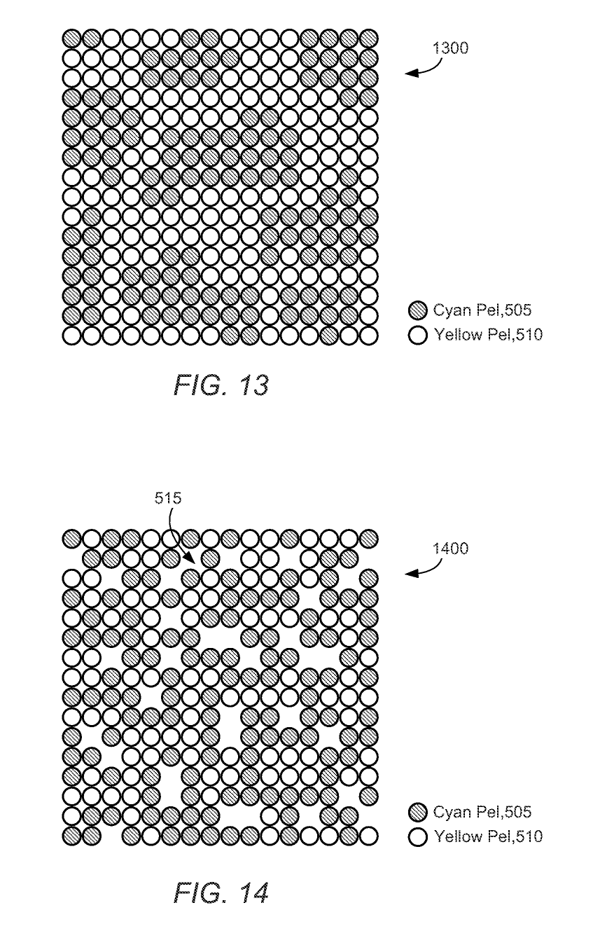

Example embodiments of improving color differentiation for use in conjunction with example method 300 are shown in FIGS. 11, 12 and 13. FIG. 12 illustrates a modified image 1200 of original pattern 500 resulting from the formula of block 320 being applied to each of the layers containing cyan pels 505 and yellow pels 510 to allow for more localized areas of cyan and yellow colors. In one alternative example embodiment, FIG. 13 shows a modified image 1300 of original pattern 500, where a more extreme color pel placement manipulation, wherein more cyan pels 505 are grouped together and separated from yellow pels 510 than in modified image 1100 and modified image 1200 of FIGS. 11 and 12, respectively.

Referring back to FIG. 3, the layer being processed is cross-checked to the number of layers generated to check whether all layers have been processed (block 325). If not all layers have been processed, the actions performed in blocks 315 and 320 may be repeated for every layer until all layers have been processed.

If all identified layers have been processed with the actions in blocks 315 and 320, a user input requiring a higher alteration of the original image may be identified (block 330). The level or degree of alteration of the original image may be configurable such that the user of client device 100 or imaging device 105 may set a level of alteration from, for example, a low level of alteration, wherein the original image may not be significantly altered, to a high level of alteration, wherein the original image may be significantly altered. The low level of alteration may include a small shift in the contrast differentiation of the original image, wherein the original image may be altered to a small extent. The high level of alteration may include an extreme shift in the contrast differentiation of the original image. In high levels of alteration, larger portions of the pels and/or more pels may be manipulated and/or processed to move like colors closer to each other and to create a more intense color differentiation of the original image.

In one example embodiment, the extent of alteration that the user requires may be a multiplier to the formula as described at block 320, which may result in the same formula being applied once on the original image for a low level or degree of alteration to modify the original image, and, for every higher level or degree of alteration the user requires, reapplying the formula on the modified image at least one more time. The process of reapplying the formula on the already-modified image may be repeated to create the extreme cases of adjustment and contrast that the user may require. In one aspect, the process of reapplying the formula on the already-modified image may be repeated even without affixing the colors in the original image to a specific pattern. In some alternative example embodiments, multiple, separate and unique formulas may be created for each level of alteration required by the user.

FIGS. 11, 12 and 13 are example embodiments of improving color differentiation for use in conjunction with the example method of FIG. 3.

In FIGS. 11, 12 and 13, an example series of possible shifts in the location of color pels as a result of applying and/or reapplying at least one formula to the modified image are shown. The levels of alteration increase from low in FIG.11 to moderate in FIG. 12 and high in FIG. 13. As seen in FIG. 11, where the level of alteration of the contrast of color pels is low, modified image 1100 shows that cyan pels 505 and yellow pels 510 are clustered together according to their level of hue in small groups. As the level of alteration increases in FIG. 12, the clustering of the pels in a specific color in modified image 1200 becomes more apparent, and the portion of the clustered pels becomes larger compared to the clustered pels in modified image 1100. As shown in FIG. 13, where there is the highest level of alteration, larger portions of the pels are clustered in modified image 1300. In FIG. 13, there are more pels that have been manipulated and/or processed for clustering similar colors closer to each other, thereby creating a more intense color differentiation between cyan pels 505 and yellow pels 510 in modified image 1300.

Referring back to FIG. 3, if the user does not require a higher alternation or the highest level of alteration desired by the user is achieved, an output of the modified image may be generated at block 335. In one alternative example embodiment, the level of alteration of the original image may not be configurable. In such example embodiment, if the action in block 325, determines that all layers have been processed, an output of the modified image may be automatically generated at block 335.

The output of the modified image may refer to a printed output on a substrate as generated by imaging device 105 or a visual output of the modified image on the display of client device 100. If the output of the modified image is determined to be a printed output, the modified image may be sent by imaging device driver 115 of client device 100 to print engine 125 of imaging device 105 for printing. If the output of the modified image is determined to be a visual output of the modified image to be displayed in the display of client device 100, imaging device driver 115 may send the modified image to the display of client device 100 for viewing by the user. In one alternative example embodiment, wherein method 300 may be performed by controller 120 of imaging device 105, controller 120 of imaging device 105 may send the modified image to print engine 125 for printing. It will be understood by one of ordinary skill in the art that there may be other forms of output by which the modified image may be produced.

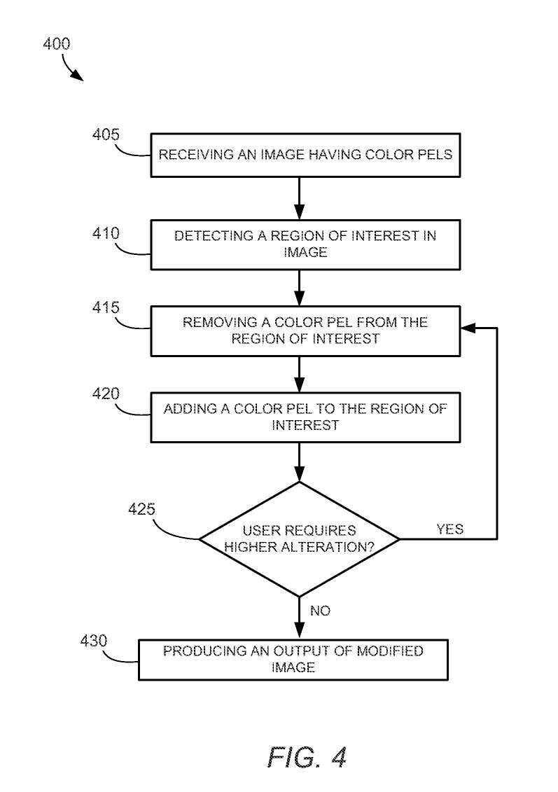

Referring to FIG. 4, there is shown a flowchart of a third example method 400 of improving color differentiation. Method 400 may utilize the same logic as that used in method 300, which adjusts the color and contrast of the original image by pulling color pels of a first color together and separating them from color pels of another color. Method 400 may alter the appearance of the original image to allow individuals with color deficiencies to distinguish color differences. Method 400 differs from methods 200 and 300 due to the alteration of the actual color of the original image by removing and/or adding color pels in the original image to create the modified image instead of just rearranging the color pels. Method 400 may allow expansion and/or compression of the color pallet or color gamut used on the original image or on a selected region being processed on the original image to create the contrast difference in the modified image.

At block 405, imaging device driver 115 or controller 120 in imaging device 105 may receive an original image having color pels. The color pels may represent color hues in the original image. As set forth above, the original image may be received by imaging device driver 115 or controller 120 in imaging device 105 when the original image is to be formatted for printing by imaging device 105. In some alternative example embodiments, the original image may be received by another application running on client device 100 to process the original image for outputting on the display of client device 100.

At block 410, a region of interest in the original image may be determined. The region of interest may refer to possible problematic region of the color spectrum for individuals with color deficiencies. For example, if the original image contains a portion having a particular color and another portion containing another color that may not be easily differentiated by an individual with color deficiencies, these portions may be determined as regions of interest.

At block 415, a color pel from the determined region of interest may be removed, and at block 420, a color pel may be added to the determined region of interest. The color pel may be removed and/or added to separate a color pel of a first color from a color pel of a second color, thereby creating the contrast difference needed for color differentiation.

FIGS. 14, 15 and 16 are example embodiments of improving color differentiation for use in conjunction with the example method of FIG. 4. In FIGS. 14, 15 and 16, modifications of the original pattern 500 are shown.

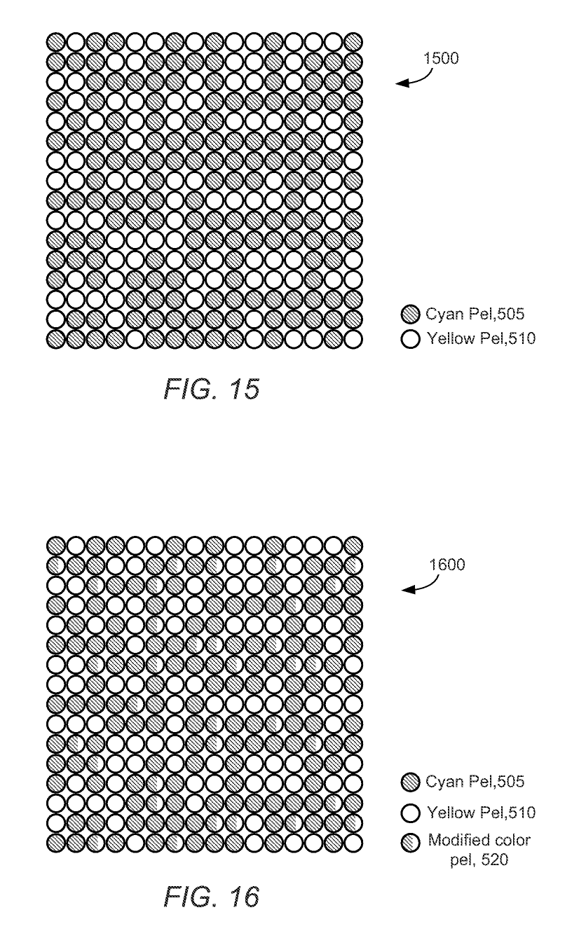

FIG. 14 shows an example embodiment of a determined region of interest 1400 that is processed to improve color differentiation by performing the action in block 415 of removing a color pel from the determined region of interest. Determined region of interest 1400 contains blank areas such as blank area 515 which indicate that pels have been removed to create a contrast difference that may be needed to differentiate one color from another. FIG. 15 shows an example embodiment of a determined region of interest 1500 that is processed to improve color differentiation by performing the action in block 420 of adding a color pel to the determined region of interest.

Blocks 415 and 420 may be used to improve contrast difference of the original image without moving a pel but rather by adding an additional color pel to a location in a determined region of interest that was not in the original image or removing a color pel that was in the original image. If more than one regions of interest are determined, the actions in block 415 and block 420 may be repeated for every region of interest detected.

In some alternative example embodiments, a color may be added or removed around the area of a color to add definition to a region on the original image, as shown in FIG. 16. This alternative example embodiment may be utilized for a more extreme case that may be needed to improve the contrast difference of the original image. Modified region of interest 1600 shows modified color pels 520 that have been added or removed with a color. Modified color pel 520 shows a single color pel having two colors, yellow and cyan, which may indicate that modified color pel 520 may have been, for example, a yellow pel in the original image that was processed to include a cyan color in the modified image.

This alternative example embodiment may be used to outline large areas of the same color in order to apply some level of differentiation to the colors adjacent to each other. For example, if a pie chart having multiple colors representing different portions of the pie is created, people with color deficiency may not be able to differentiate two adjacent colors and misinterpret two slices of the pie chart as only a single slice. Creating an outline between adjacent colors may create a contrast difference between the two adjacent colors and enable individuals with color deficiency to identify one color from the other. This alternative example embodiment may be used on solid color graphics such as, for example, chart and presentation documents where the difference in colors may be sharp and defined. This alternative example embodiment may also be used for images having multiple but few colors per page and for images that use a large portion of the color table. This alternative example embodiment of improving contrast difference may be used on all colors of the original image or only on a determined region of interest.

In some other alternative example embodiments, another method of producing the effect of adding and/or reducing a specific color to an image may involve utilizing a different color table or a color table adjustment factor that shifts the colors of the color spectrum in the determined region of interest to alter the contrast difference of the original image. In one aspect of such alternative example embodiments, the colors in the determined region of interest may be assigned a new color table that is slightly shifted. The original color table that is used in the original image may be converted to a shifted color table that may include a rotation of the color table such as, for example, turning a blue colored pel into a red colored pel, the red colored pel into a yellow colored pel, and the yellow colored pel into a blue colored pel.

In another aspect of such alternative example embodiment, the shifted color table may be a compressed color table that may eliminate specific colored pels in the original image. For example, the shifted color table may determine green and red colored pels and remove them from the original image so that the differences between the green colored pels is now a steep change instead of a gradual slope.

Referring back to FIG. 4, a user input requiring a higher alteration of the original image may be identified at block 425. As set forth above, the level or degree of alteration of the original image may be configurable such that the user of client device 100 or imaging device 105 may set a level of alteration from, for example, a low level of alteration, wherein the original image may not be significantly altered, to a high level of alteration, wherein the original image may be significantly altered. The low level of alteration may include a small shift in the contrast differentiation of the original image, wherein the original image may be altered to a small extent. The high level of alteration may include an extreme shift of the contrast differentiation of the original image. In high levels of alteration, larger portions of the pels and/or more pels may be manipulated and/or processed to move like colors closer to each other and create a more intense color differentiation in the original image.

If the user requires a higher level of alteration, the process repeats the actions in blocks 415 and 420. The number of times the actions in blocks 415 and 420 are performed on the determined region of interest depends on the level of alteration required by the user.

If, at block 425, it is determined that the user does not require a higher level of alteration or the level of alteration desired by the user is achieved, an output of the modified image may be generated (block 430). In an alternative example embodiment, the level of alteration of the original image may not be configurable. In such example embodiment, if the action in block 425 determines that all layers have been processed, an output of the modified image may be automatically generated at block 430.

The output may refer to print data corresponding to the modified image that is sent to print engine 125 of imaging device 105 or to visual data that is presented on a display in or associated with client device 100 for viewing by the user of client device 100.

It will be appreciated that although the examples described and shown above use two colors to create another perceived color, other colors in any number and combination may be used to produce the colors printed on a substrate or displayed on an output device. It will be appreciated that while there may be a single pel or two of a color that may be used, the logic of the aforementioned example embodiments includes the understanding of all possible color combinations and includes applying various formulas to manipulate the pels of an image or colored document that allow improved legibility and contrast difference in color documents for individuals with color deficiency.

It will be appreciated that the actions described and shown in the example flowcharts may be carried out or performed in any suitable order. It will also be appreciated that not all of the actions described in FIGS. 2, 3 and 4 needs to be performed in accordance with the example embodiments of the disclosure and/or additional actions may be performed in accordance with other example embodiments of the disclosure.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific example embodiments disclosed and that modifications and other embodiments are intended to be included within the scope of the appended claims. Although specific terms are employed herein, they are used in a generic and descriptive sense only and not for purposes of limitation.

What is claimed is:

1. A method, comprising:
receiving an original image containing color pels of a plurality of colors;
detecting at least one region of interest in the original image; and
modifying the original image to improve a contrast between a first color and a second color of the plurality of colors.

2. The method of claim 1, wherein the modifying the original image includes removing a color pel of the first color from the at least one region of interest.

3. The method of claim 1, wherein the modifying the original image includes adding a color pel of the first color to the at least one region of interest.

4. The method of claim 1, further comprising creating an outline of the at least one region of interest by adding at least one color pel around the color pels of the first color in the region of interest.

5. The method of claim 2, wherein the removing the color pel of the first color from the at least one region of interest is based upon a formula.

6. The method of claim 2, wherein the removing the color pel of the first color from the at least one region of interest is based upon a color table adjustment factor that shifts the plurality of colors of the color pels in the at least one region of interest.

7. The method of claim 1, further comprising creating an outline of the at least one region of interest by removing at least color pel around the color pels of the first color from the at least one region of interest.

8. The method of claim 1, wherein the at least one region of interest is a potentially problematic region of a color spectrum for individuals with a color deficiency.

9. The method of claim 1 further comprising, sending the modified image to an imaging device for printing.

10. A method of improving color differentiation, comprising:
receiving an image containing color pels of a plurality of colors;
detecting a region of interest in the image;
creating a contrast difference between a first color and a second color of the plurality of colors by:
removing a color pel of the first color from the at least one region of interest; and
adding a color pel of the first color to the region of interest.

11. The method of claim 9, wherein the removing of the color pel is based upon a formula.

12. The method of claim 9, wherein the removing of the color pel is based upon a color table adjustment factor that shifts the plurality of colors of the color pels in the at least one region of interest.

13. The method of claim 9, further comprising adding definition to the region of interest by removing a color pel around the first color in the region of interest.

14. The method of claim 9 further comprising creating an outline of the region of interest by adding at least one color pel around the color pels of the first color in the region of interest.

15. The method of claim 9 further comprising converting a color table of the image into a shifted color table having a different color assigned to at least one of the plurality of colors in the image.

16. A computing device with a non-transitory computer-readable storage medium containing computer executable instructions to:
receive an original image containing color pels of a plurality of colors;
determine at least one region of interest in the original image;
improve a contrast between a first color of the plurality of colors and a second color of the plurality of colors by:
removing a color pel of the first color from the at least one region of interest; and
adding a color pel of the first color to the at least one region of interest.

17. The computing device of claim 16, further comprising a computer executable instruction to convert a color table of the original image to a shifted color table having a different color assigned to at least one color of the plurality of colors.

18. The computing device of claim 16, further comprising a computer executable instruction to convert a color table of the original image to a shifted color table to eliminate a color in the original image.

19. The computing device of claim 16, wherein the computer executable instruction to improve the contrast by the adding the color pel includes adding at least one color pel around the color pels of the first color in the region of interest to create an outline of the at least one region of interest.

20. The computing device of claim 16, wherein the computer executable instruction to improve the contrast by the removing the color pel includes removing at least one color pel around the color pels of the first color in the at least one region of interest to add definition to the at least one region of interest.
